(19) United States
(12) Patent Application Publication
(10) Pub. No.: US 2020/0338736 A1
(43) Pub. Date: Oct. 29, 2020

(54) ROBOT TEACHING DEVICE

(71) Applicant: Fanuc Corporation, Minamitsuru-gun (JP)

(72) Inventor: Teppei Hoshiyama, Minamitsuru-gun (JP)

(73) Assignee: Fanuc Corporation, Minamitsuru-gun (JP)

(21) Appl. No.: 16/839,298

(22) Filed: Apr. 3, 2020

(30) Foreign Application Priority Data
Apr. 26, 2019 (JP) 2019-086731

(51) Int. Cl. B25J 9/16; B25J 11/00; B25J 9/00

(52) U.S. Cl. CPC B25J 9/1679; B25J 9/0081; B25J 11/0005; B25J 9/161

(57) ABSTRACT

A robot teaching device configured to perform teaching of a robot that includes a display device, a microphone configured to collect voice and output a voice signal, a voice recognition section configured to identify one or more words represented by the voice from the voice signal and output character data constituted by the one or more words, a program editing section configured to create an editing screen of an operation program for the robot and display the editing screen on the display device, and a comment input section configured to, in a state in which the editing screen of the operation program is displayed on the display device, add a word represented by the character data outputted from the voice recognition section, as a comment text, to a command in the operation program.

### BACKGROUND OF THE INVENTION

### 1. Field of the Invention

The present invention relates to a robot teaching device.

### 2. Description of the Related Art

An operation program for a robot is generally created and edited by operating a teaching device with keys. JP 2006-68865 A and JP 2005-18789 A each describes an example of a teaching device having a voice input function. JP 2006-68865 A describes “in the case of the present invention, when an operator presses the voice input activation switch 7 and speaks a desired operation menu to the voice input section 6, the voice recognition processing section 8 converts a voice signal inputted in the voice input section 6 to a corresponding text, the text is compared with a registration menu in the storage means 10d, and the registered operation menu screen is selected and displayed on the display screen 5c” (paragraph 0009). JP 2005-18789 A describes “a program editing device, comprising: a voice input means; a means for storing a plurality of patterns for fitting one or more character strings into a predetermined location to complete a sentence; a character string candidate storage means for storing a plurality of character string candidates to be fitted into the patterns; a correspondence storage means for storing a correspondence between a sentence completed by fitting the character string candidate into the pattern and a command to use in a teaching program for a robot; a search means which searches for, from sentences obtained by fitting one of the character string candidates into one of the stored patterns, a sentence that matches the sentence inputted from the voice input means; and a means for converting the matching sentence searched by the search means, into a robot command, based on the correspondence stored in the correspondence storage means, and inserting the robot command into the teaching program” (claim 1).

### SUMMARY OF THE INVENTION

In teaching of a robot using a teaching device, an operator performs another task in parallel with the teaching of the robot in some cases. There is a desire for a robot teaching device that can further reduce a load for the operator in the teaching of the robot. An aspect of the present disclosure is a robot teaching device configured to perform teaching of a robot, that includes a display device, a microphone configured to collect voice and output a voice signal, a voice recognition section configured to identify one or more words represented by the voice from the voice signal and output character data constituted by the one or more words, a program editing section configured to create an editing screen of an operation program for the robot and display the editing screen on the display device, and a comment input section configured to, in a state in which the editing screen of the operation program is displayed on the display device, add a word represented by the character data outputted from the voice recognition section, as a comment text, to a command in the operation program.

### BRIEF DESCRIPTION OF THE DRAWINGS

The objects, features and advantages of the present invention will become more apparent from the following description of the embodiments in connection with the accompanying drawings, wherein:

FIG. 1 is a diagram illustrating an overall configuration of a robot system including a robot teaching device according to an embodiment;

FIG. 2 is a function block diagram of the robot teaching device;

FIG. 3 is a flowchart illustrating voice input processing;

FIG. 4 is a diagram illustrating an example of an editing screen of an operation program;

FIG. 5 is a flowchart illustrating language switching processing;

FIG. 6 is a flowchart illustrating voice input teaching processing;

FIG. 7 illustrates an example of a message image for requesting execution permission of an instruction inputted by voice;

FIG. 8 is a flowchart illustrating the voice input teaching processing in a case where there is association that a word represented by voice includes a word included in a recognition target word;

FIG. 9 illustrates a selection screen as an example of a list displayed on a display device in the voice input teaching processing in FIG. 8;

FIG. 10 is a flowchart illustrating the voice input teaching processing in a case where there is association that a word represented by inputted voice includes a word having a meaning similar to that of a recognition target word; and

FIG. 11 illustrates a selection screen as an example of a list displayed on the display device in the voice input teaching processing in FIG. 10.

### DETAILED DESCRIPTION

Embodiments of the present invention will be described below with reference to the accompanying drawings. Throughout the drawings, corresponding components are denoted by common reference numerals. For ease of understanding, these drawings are scaled as appropriate. The embodiments illustrated in the drawings are examples for implementing the present invention, and the present invention is not limited to the embodiments illustrated in the drawings.

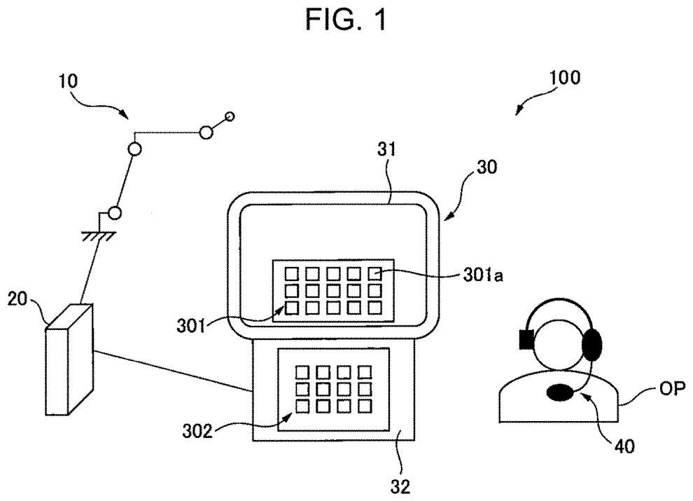

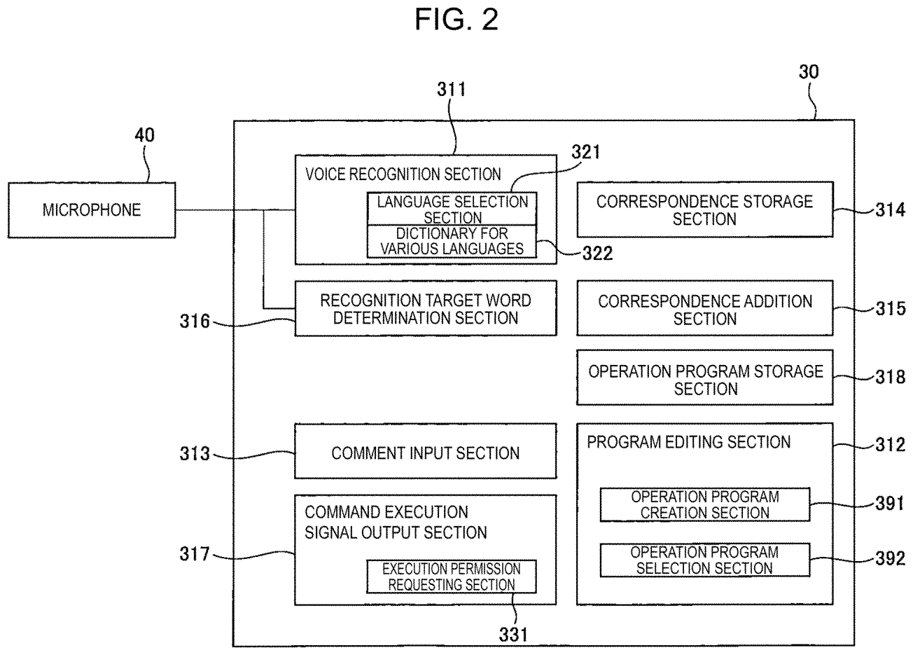

FIG. 1 is a diagram illustrating an overall configuration of a robot system 100 including a robot teaching device 30 according to an embodiment. FIG. 2 is a function block diagram of the robot teaching device 30. As illustrated in FIG. 1, the robot system 100 includes a robot 10, a robot controller 20 for controlling the robot 10, and the robot teaching device 30 connected to the robot controller 20. A microphone 40 that collects voice and outputs a voice signal is connected to the robot teaching device 30 by wire or wirelessly. As an example, in FIG. 1, the microphone 40 is configured as a headset-type microphone worn by an operator OP operating the robot teaching device 30. Note that, the microphone 40 may be incorporated into the robot teaching device 30.

The robot 10 is a vertical articulated robot, for example. Another type of robot may be used as the robot 10. The robot controller 20 controls operation of the robot 10 in response to various commands inputted from the robot teaching device 30. The robot controller 20 may have a configuration as a general computer including a CPU, a ROM, a RAM, a storage device, a display section, an operation section, an external device interface, a network interface, and the like. The robot teaching device 30 is, for example, a hand-held information terminal such as a teach pendant, a tablet terminal, or the like. The robot teaching device 30 may have a configuration as a general computer including a CPU, a ROM, a RAM, a storage device, a display section, an operation section, an external device interface, a network interface, and the like.

The robot teaching device 30 includes a display device 31 and an operation section 32. Hard keys (hardware keys) 302 for teach input are disposed on the operation section 32. The display device 31 includes a touch panel, and soft keys 301 are disposed on a display screen of the display device 31. The operator OP can operate operation keys (the hard keys 302 and the soft keys 301) to teach to or operate the robot 10. As illustrated in FIG. 2, the robot teaching device 30 includes a voice recognition section 311 configured to identify one or more words represented by voice from a voice signal inputted from the microphone 40 and output character data constituted by the one or more words, a program editing section 312 configured to create an editing screen of an operation program for the robot 10 and display the editing screen on the display device 31, and a comment input section 313 configured to, in a state in which the editing screen of the operation program is displayed on the display device 31, add a word represented by the character data outputted from the voice recognition section 311, as a comment text, to a command in the operation program. This configuration allows the operator OP, even in a situation in which both hands are occupied for manually operating the robot teaching device 30 to teach the robot 10, to input a comment text into the operation program by voice and create a highly readable operation program. Thus, a load for the operator in teaching of the robot is reduced.

Functions of the robot teaching device 30 will be described with reference to FIG. 2. The robot teaching device 30 further includes a correspondence storage section 314 configured to store each of a plurality of types of commands used in teaching of the robot 10 in association with a recognition target word, a correspondence addition section 315 configured to set an added comment text as a new recognition target word, and add, to the correspondence storage section 314, the new recognition target word while associating the new recognition target word with a command to which a comment text in an operation program is added, a recognition target word determination section 316 configured to determine whether a recognition target word stored in the correspondence storage section 314 is included in the word represented by character data, and a command execution signal output section 317 configured to output, to the robot controller 20, a signal for executing a command stored in the correspondence storage section 314 in association with a recognition target word determined to be included in the word represented by the character data. Various functions of the robot teaching device 30 illustrated in FIG. 2 can be implemented by software, or by cooperation between hardware and software.

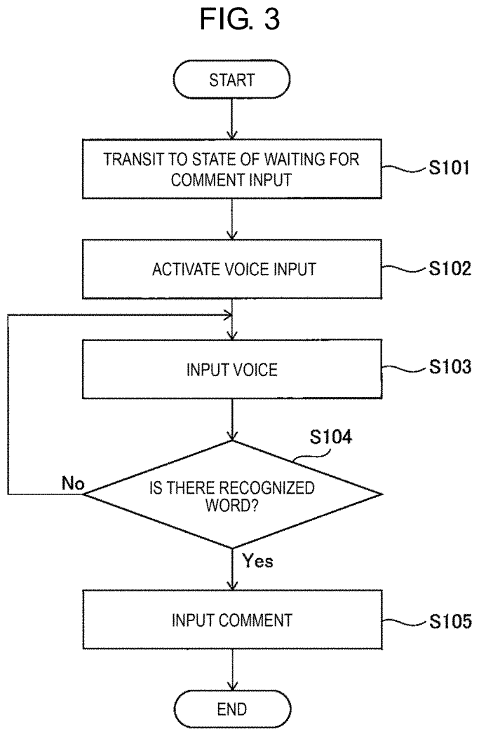

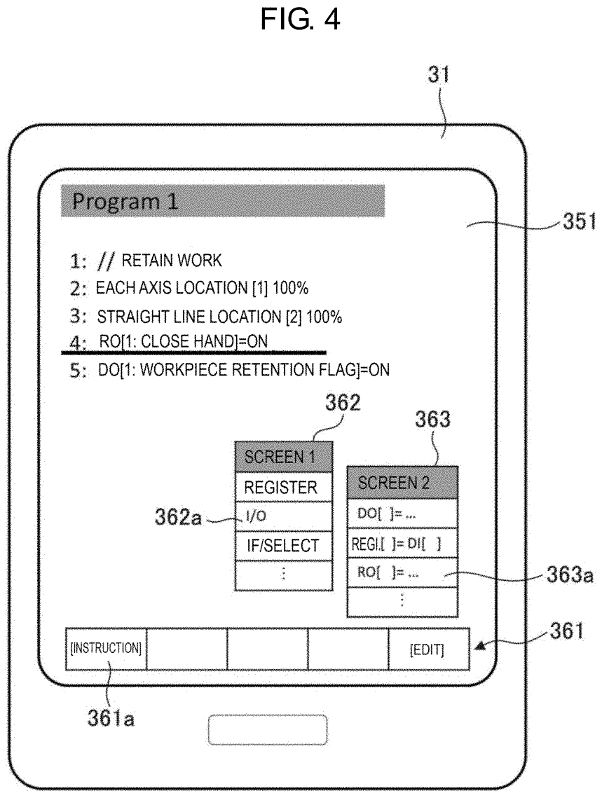

Next, comment input processing performed in the robot teaching device 30 having the configuration described above will be described with reference to FIG. 3 and FIG. 4. FIG. 3 is a flowchart of the comment input processing, and FIG. 4 illustrates an example of an editing screen on the display device 31 when an operation program is created and edited. The comment input processing in FIG. 3 is performed under control of a CPU of the robot teaching device 30. Initially, the operator OP operates the soft key or the hard key to select a command for which comment input is to be performed in an operation program being created, and transits the robot teaching device 30 to a state of waiting for comment input (step S101). As used herein, a word “command” has meanings including an instruction (including a macro instruction) for a robot, data associated with an instruction, various data pertaining to teaching, and the like. A description will be given of a situation in which, in an editing screen 351 as illustrated in FIG. 4, a comment text of “CLOSE HAND” is added to an instruction

“ROM” in a fourth line by voice input. For example, the operator OP selects the fourth line of the operation program by a touch operation or the like, and inputs a symbol indicating comment input at an input position of the comment text to shift the robot teaching device 30 to the state of waiting for comment input.

Next, the operator OP operates a voice activation switch 301a (see FIG. 1) disposed as one of the soft keys 301 to set the robot teaching device 30 to a state in which voice input is active (step S102). Here, the state in which the voice input is active is a state in which the microphone 40, the voice recognition section 311, and the recognition target word determination section 316 are ready to operate. Note that, the voice activation switch 301a may be disposed as one of the hard keys 302. The voice activation switch 301a functions, for example, when once depressed, to activate voice input and maintain the state, and when depressed again, deactivate the voice input to accept input by the soft keys and the hard keys.

Next, the operator OP inputs a comment text by voice (step S103). The voice recognition section 311 performs voice recognition processing on a voice signal inputted from the microphone 40 based on dictionary data 322, and identifies one or more words from the voice signal. The dictionary data 322 includes various types of dictionary data necessary for voice recognition such as an acoustic model, a language model, and the like, for a plurality of types of languages. When there is no identified word (S104: No), the processing returns to step S103. When there is an identified word (S104: Yes), the robot teaching device 30 inputs a comment text into a selected command (step S105).

In the editing screen 351 in FIG. 4, each of “RETAIN WORKPIECE” in the first line, “CLOSE HAND” in the fourth line, “WORKPIECE RETENTION FLAG” in the fifth line is an example of a comment text inputted by voice into the operation program by the comment input processing in FIG. 3. “RETAIN WORKPIECE” in the first line is a comment text for an entirety of the operation program in FIG. 4, and indicates that the operation program performs a “retain a work” operation. “CLOSE HAND” in the fourth line indicates that an instruction “RO[1]=ON” is an operation to “close a hand” of the robot 10. “WORKPIECE RETENTION FLAG” in the fifth line indicates that the instruction “DO[1]=ON” is an instruction to set a flag indicating the workpiece retention operation. According to the above-described comment input processing, the operator OP, even in a situation in which both hands are occupied for manually operating the robot teaching device 30 to teach to the robot 10, can input a comment text into the operation program by voice and create a highly readable operation program. Thus, a load for the operator in teaching of the robot is reduced.

As illustrated in FIG. 2, the voice recognition section 311 may include a language selection section 321 that displays a selection screen for selecting a language to be a target for voice identification on the display device 31, and accepts language selection by a user operation. The voice recognition section 311 includes the dictionary data 322 for the various languages, and can perform identification of a word based on a voice signal, by using dictionary data of a language selected by a user via the language selection section 321. In addition, by storing recognition target words for various languages in the correspondence storage section 314, the recognition target word determination section 316 can perform identification of a recognition target word based on the language selected by the user via the language selection section 321.

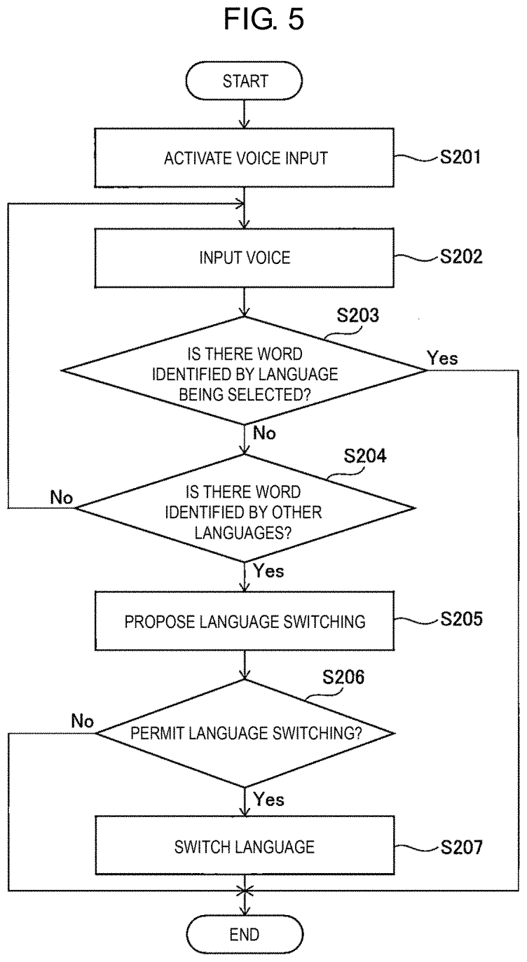

The robot teaching device 30 (voice recognition section 311) may have a function that estimates a language of voice by using the dictionary data 322 for the plurality of languages, and when an estimated language differs from the language being selected via the language selection section 321, displays an image indicating a message prompting switching of the language being selected to the estimated language on the display device 31. FIG. 5 is a flowchart illustrating the language switching processing described above. The language switching processing operates, for example, in a state of waiting for comment input as in step S101 in FIG. 3, or in a state of waiting for teach input. Initially, the operator OP operates the voice activation switch 301a to activate voice input (step S201). In this state, the operator OP performs voice input (step S202).

Next, the robot teaching device 30 determines whether there is a word identified by the language selected by the language selection section 321 in inputted voice (step S203). When there is a word identified by the language selected by the language selection section 321 (S203: Yes), the language switching processing ends. On the other hand, when there is no word identified by the language selected by the language selection section 321 (S203: No), the robot teaching device 30 uses the dictionary data 322 for various languages to determine whether there is a word identified by languages other than the language selected by the language selection section 321 in the inputted voice (step S204). As a result, when there is a word identified by another language (S204: Yes), the display device 31 is caused to display a message that prompts to switch a language to be a target for voice identification to the other language determined in step S204 (step S205). When there is no word identified by the other languages (S204: No), the processing returns to step S202.

Next, the robot teaching device 30 accepts a user operation to determine whether to permit switching to the language proposed in step S205 (step S206). When an operation for permitting the switching to the proposed language is performed (S206: Yes), the robot teaching device 30 switches to the proposed language (step S207). When, on the other hand, the switching to the proposed language is not permitted (S206: No), the language switching processing ends. Note that, a recognition target word is also stored in the correspondence storage section 314 for the plurality of types of languages. Thus, when the language is switched in step S207, the recognition target word determination section 316 can perform identification of a recognition target word by the switched language.

Next, a teaching function by voice input provided by the robot teaching device 30 (including execution of a command to the robot 10, input of a command to an operation program, and the like) will be described. Before describing convenience of the teaching function by voice input by the robot teaching device 30, an operation example of a case in which the operation program illustrated in FIG. 4 is inputted by a manual operation will be described. In order to input an instruction, for example, to the fourth line in the editing screen 351 of the operation program (“Program 1”) illustrated in FIG. 4, the operator OP selects the fourth line by a key operation. Next, the operator OP selects an item “INSTRUCTION” (reference sign 361a) for inputting an instruction from a selection menu screen 361 on a lower portion of the editing screen 351 by a key operation. Then, a pop-up menu screen 362 in which classification items of instructions are listed is displayed. The operator OP selects, via a key operation, an item “I/O” (reference sign 362a) for inputting an I/O instruction. Then, a pop-up menu image 363 is displayed listing specific instructions that correspond to an I/O instruction. Here, the operator OP selects an instruction

“RO[]=” (363a) by a key operation, inputs 1 into “[]” as an argument, and also inputs “ON” to a right of an equal symbol “=”. When performing such a manual key operation, the user needs to know in advance that the instruction “RO[]=” is in the item “I/O” (reference sign 362a) in the selection menu screen 361.

The robot teaching device 30 according to the present embodiment stores a recognition target word in the robot teaching device 30 in advance, so that the operator OP is not required to have detailed knowledge about instructions, and can perform input of a desired instruction, and the like, by speaking words that are easy to understand for the operator OP. In addition, the robot teaching device 30 automatically registers the inputted comment text described above as a recognition target word. This allows the operator OP to input an instruction “RO[1]=ON”, by speaking, for example, “CLOSE HAND” on the editing screen of the operation program, without performing operations to follow the menu screens hierarchically configured as described above.

The above teaching function by voice input is implemented, by the recognition target word determination section 316 that determines whether a recognition target word stored in the correspondence storage section 314 is included in a word represented by voice, and by the command execution signal output section 317 that outputs, to the robot controller 20, a signal for executing a command stored in the correspondence storage section 314 in association with the determined recognition target word. Table 1 below illustrates an example of information stored in the correspondence storage section 314. In Table 1, four recognition target words “EACH AXIS LOCATION”, “EACH AXIS”, “EACH AXIS POSITION”, “LOCATION TEACHING” are associated with an instruction “EACH AXIS LOCATION”. In this case, the operator OP, by speaking any of the four recognition target words “EACH AXIS LOCATION”, “EACH AXIS”, “EACH AXIS POSITION”, “LOCATION TEACHING”, can execute the instruction “EACH AXIS LOCATION” or input the instruction to the operation program. Each of an instruction “STRAIGHT LINE LOCATION”, an instruction “DO[]”, and the instruction “RO[]” is also associated with four recognition target words.

TABLE 1

| PRO- | RECOG- | RECOG- | RECOG- | RECOG- |
|---|---|---|---|---|
| GRAM | NITION | NITION | NITION | NITION |
| INSTRUC- | TARGET | TARGET | TARGET | TARGET |
| TION | WORD 1 | WORD 2 | WORD 3 | WORD 4 |
| EACH | EACH | EACH | EACH | LOCA- |
| AXIS | AXIS | AXIS | AXIS | TION |
| LOCA- | LOCA- | | PO- | TEACH- |
| TION | TION | | SITION | ING |
| STRAIGHT | STRAIGHT | STRAIGHT | STRAIGHT | LOCA- |
| LINE | LINE | LINE | LINE | TION |
| LOCA- | LOCA- | | PO- | TEACH- |
| TION | TION | | SITION | ING |
| DO [ . . . ] | DO | DIGITAL | CLOSE | OUTPUT |
| | | OUTPUT | HAND | |
| RO [ . . . ] | RO | ROBOT | WORK- | OUTPUT |
| | | OUTPUT | PIECE | |
| | | | RETEN- | |
| | | | TION | |
| | | | FLAG | |

In Table 1, “D 0”, “DIGITAL OUTPUT”, “OUTPUT” among four recognition target words associated with the instruction “DOH” are pre-registered recognition target words, and “CLOSE HAND” is a recognition target word added to the correspondence storage section 314 by the correspondence addition section 315 in conjunction with voice input of a comment text to the operation program. In Table 1, “RO”, “ROBOT OUTPUT”, “OUTPUT” among four recognition target words associated with the instruction “RO[]” are pre-registered recognition target words, and “WORKPIECE RETENTION FLAG” is a recognition target word added to the correspondence storage section 314 by the correspondence addition section 315 in conjunction with voice input of a comment text to the operation program. In this manner, since the word voice-inputted as a comment text by the operator OP is automatically added to the correspondence storage section 314 as the recognition target word, after that, the operator OP can execute a desired instruction or input the desired instruction into the operation program by speaking the recognition target word that has been used by the operator OP and that is easy to understand for the operator OP.

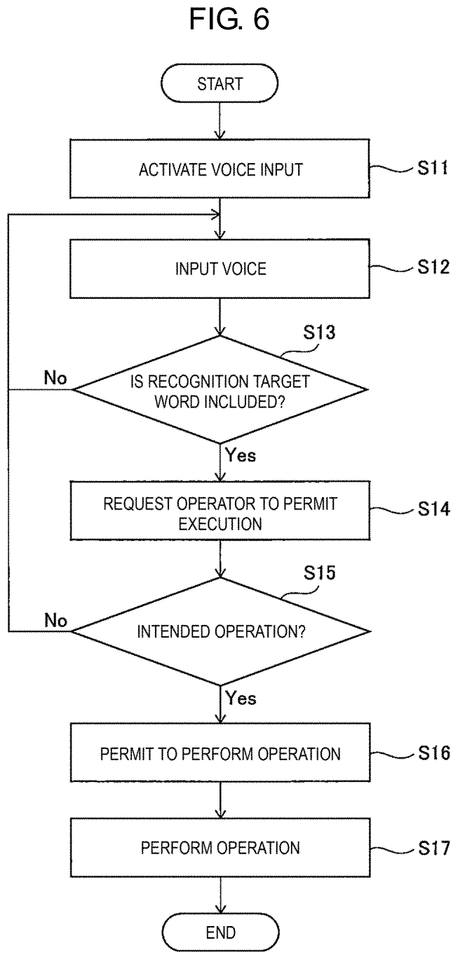

FIG. 6 is a flowchart illustrating the teaching function by voice input (hereinafter referred to as voice input teaching processing). The voice input teaching processing in FIG. 6 is performed under control of the CPU of the robot teaching device 30. The operator OP, for example, in a state in which the robot teaching device 30 accepts teach input, operates the voice activation switch 301a to activate voice input (step S11). Next, the operator OP speaks a recognition target word corresponding to a desired instruction (step S12). As an example, a case is assumed in which the operator OP speaks “HAND OPEN” intended an instruction “HOP” for opening a hand of the robot 10. The robot teaching device 30 identifies whether the word inputted by voice includes a recognition target word stored in the correspondence storage section 314 (step S13). When the word inputted by voice does not include a recognition target word (S13: No), the processing returns to step S12. Here, assume that “HAND OPEN” spoken by the operator OP is stored in the correspondence storage section 314 as a recognition target word. In this case, it is determined that the word inputted by voice includes the recognition target word (S13: Yes), and the processing proceeds to step S14.

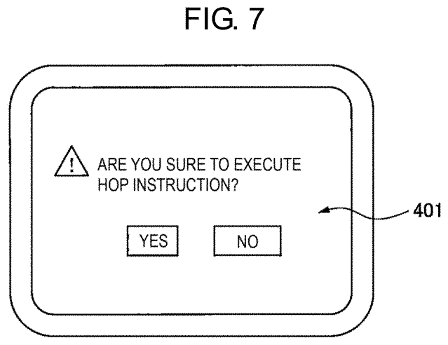

Next, the robot teaching device 30 (execution permission requesting section 331) displays, on the display device 31, a message screen 401 (see FIG. 7) for requesting the operator OP to permit execution of the instruction inputted by voice (step S14). The message screen 401 includes buttons (“YES”, “NO”) for accepting an operation by the operator OP to select whether to permit instruction execution. In step S15, a selection operation from the operator OP is accepted. The operator OP can operate the button on the message screen 401 to instruct whether to execute the instruction “HOP”. When an operation to permit execution of the instruction is accepted (S15: Yes), the command execution signal output section 317 interprets that the instruction execution is permitted (step S16), and sends a signal for executing the instruction to the robot controller 20 (step S17). When an operation that does not permit execution of the instruction is accepted (S15: No), the processing returns to step S12.

In step S15, the robot teaching device 30 may be configured to accept a selection operation by voice input while the message screen 401 is displayed. In this case, when the voice recognition section 311 can identify the word “YES” for permitting execution of the instruction, the robot teaching device 30 determines that execution of the instruction is permitted. The command execution signal output section 317 sends a signal for executing the instruction “HOP” to the robot controller 20.

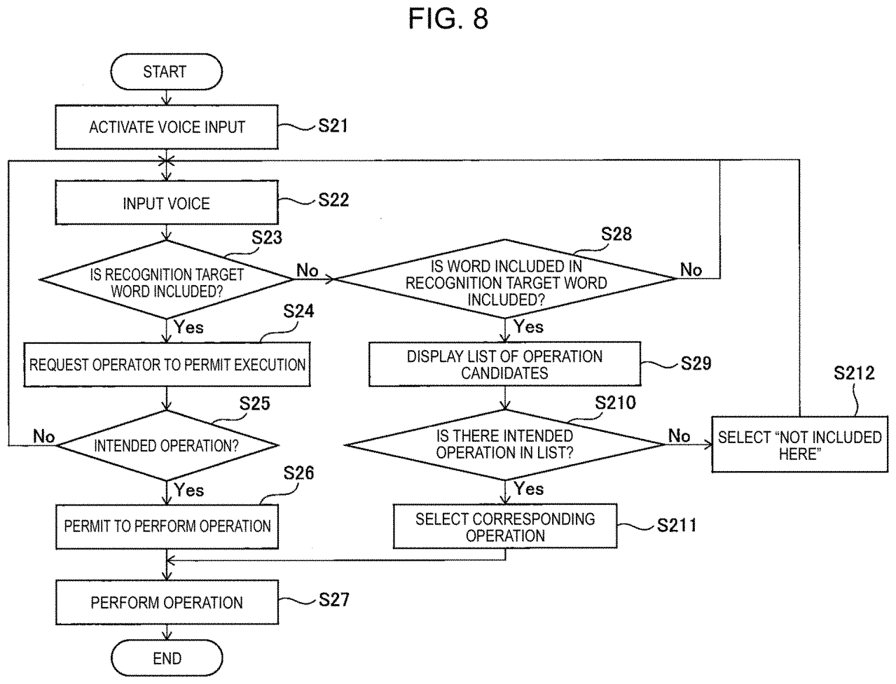

The recognition target word determination section 316 may be configured to, when the word represented by the inputted voice does not include a recognition target word stored in the correspondence storage section 314, extract, from the correspondence storage section, one or more recognition target words having predetermined association with the word represented by the voice, and display a selection screen on the display device 31 for accepting operation input to select one from one or more instructions associated with the extracted one or more recognition target words in the correspondence storage section 314. With reference to FIG. 8 to FIG. 11, two examples of such functions by the recognition target word determination section 316 will be described.

FIG. 8 is a flowchart illustrating voice input teaching processing, in a case in which a word represented by inputted voice and a recognition target word stored in the correspondence storage section 314 have association that, the word represented by voice includes a word included in the recognition target word. In the flowchart in FIG. 8, steps S21 to S27 have the same processing contents as those of steps S11 to S17 in FIG. 6, respectively, and thus descriptions thereof will be omitted. When, in step S23, the word inputted by voice is determined not to include a recognition target word (S23: No), the processing proceeds to step S28.

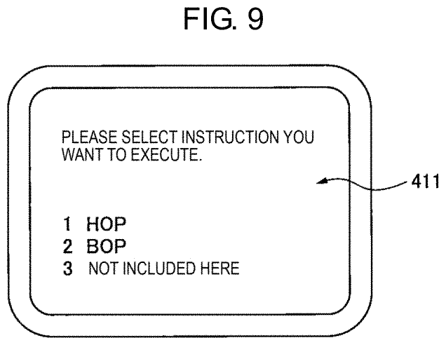

In step S28, the robot teaching device 30 determines whether the word represented by voice includes a word included in a recognition target word. When the word represented by voice includes a word included in a recognition target word (S28: Yes), the robot teaching device 30 extracts a recognition target word having association that the word represented by voice includes the word included in the recognition target word, from the correspondence storage section 314. The robot teaching device 30 then displays a list of instructions associated with the extracted recognition target word in the correspondence storage section 314 as candidates on the display device 31 (step S29). When the word represented by voice does not include a word included in a recognition target word (S28: No), the processing returns to step S22. FIG. 9 illustrates the selection screen 411 as an example of the list displayed on the display device 31 in step S29. For example, as illustrated in Table 2 below, when a speech of the operator OP includes “OPEN”, then “HAND OPEN” and “BOX OPEN” that are recognition target words may be extracted as candidates. Also, as illustrated in Table 2 below, when the speech of the operator OP includes “HAND”, then “HAND OPEN” and “HAND CLOSE” that are recognition target words may be extracted as candidates.

TABLE 2

| | CANDIDATES AS |
|---|---|
| SPEECH OF | RECOGNITION |
| OPERATOR | TARGET WORD |
| — OPEN | HAND OPEN |
| | BOX OPEN |
| HAND — | HAND OPEN |
| | HAND CLOSE |

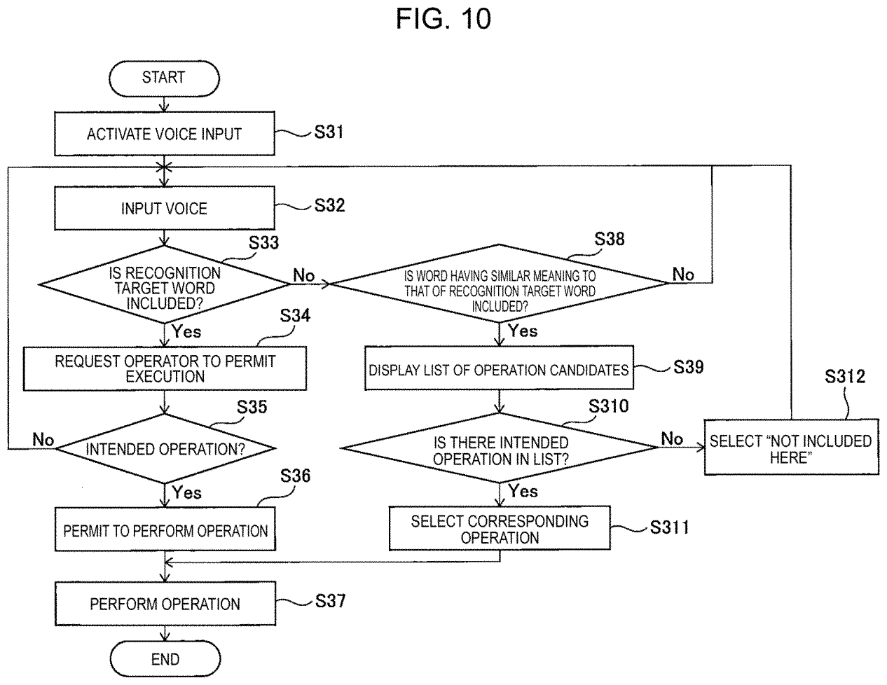

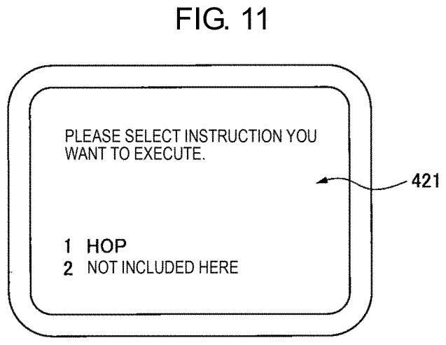

The selection screen 411 in FIG. 9 is an example of a case in which the speech of the operator OP includes “OPEN”, then “HAND OPEN” and “BOX OPEN” that are the recognition target words are extracted as the candidates. The robot teaching device 30 accepts a selection operation via the selection screen 411 by the operator OP (step S210). The robot teaching device 30, when the selection operation specifying any operation (instruction) is accepted via the selection screen 411 (S210: Yes), selects and performs the specified operation (instruction) (steps S211, S27). When there is no operation intended by the operator OP in the selection screen 411 (S210: No), and the operator OP selects “NOT INCLUDED HERE” on the selection screen 411 (S212), the processing returns to step S22. In accordance with the voice teach input processing described in FIGS. 10 and 11, even when the robot teaching device 30 can recognize only a portion of contents of the speech by the operator OP, the operator OP can give a desired instruction.

FIG. 10 is a flowchart illustrating the voice input teaching processing in a case in which a word represented by inputted voice and a recognition target word stored in the corresponding storage section 314 have association that the word represented by the inputted voice includes a word having a meaning similar to that of the recognition target word stored in the correspondence storage section 314. In the flowchart in FIG. 10, steps S31 to S37 have the same processing contents as those of steps S11 to S17 in FIG. 6, respectively, and thus descriptions thereof will be omitted. When, in step S33, the word inputted by voice is determined not to include a recognition target word (S33: No), the processing proceeds to step S38.

In step S38, the robot teaching device 30 determines whether the word represented by voice includes a word having a meaning similar to that of a recognition target word. When the word represented by voice includes a word having a meaning similar to that of the recognition target word (S38: Yes), the robot teaching device 30 extracts a recognition target word having association that the word represented by voice includes a word having a meaning similar to that of the recognition target word, from the correspondence storage section 314. As an example, the robot teaching device 30 (recognition target word determination section 316) may have dictionary data that associates a word that can be a recognition target word with a word having a meaning similar to that of such a word. The robot teaching device 30 then displays a list of instructions associated with the extracted recognition target word in the correspondence storage section 314 as candidates on the display device 31 (step S39). FIG. 11 illustrates a selection screen 421 as an example of the list displayed on the display device 31 in step S39. For example, as illustrated in Table 3 below, when the speech of the operator OP is “OPEN HAND” or “PLEASE OPEN HAND”, then the robot teaching device 30 can interpret contents of the speech, to extract “HAND OPEN” as a recognition target word having a meaning similar to that of the contents of the speech. Further, as illustrated in Table 3 below, when the speech of the operator OP is “CLOSE HAND” or “PLEASE CLOSE HAND”, then the robot teaching device 30 can interpret contents of the speech, to extract “HAND CLOSE” as a recognition target word having a meaning similar to that of the contents of the speech.

TABLE 3

| | CANDIDATES AS |
|---|---|
| SPEECH OF | RECOGNITION |
| OPERATOR | TARGET WORD |
| OPEN HAND | HAND OPEN |
| PLEASE OPEN HAND | |
| CLOSE HAND | HAND CLOSE |
| PLEASE CLOSE HAND | |

The selection screen 421 in FIG. 11 is an example of a case in which, when the speech of the operator OP is “OPEN HAND”, and “HAND OPEN” that is the recognition target word is extracted as a candidate. The robot teaching device 30 accepts a selection operation via the selection screen 421 by the operator OP (step S310). The robot teaching device 30, when the selection operation specifying any operation (instruction) is accepted via the selection screen 421 (S310: Yes), selects and performs the specified operation (instruction) (steps S311, S37). When there is no operation intended by the operator OP in the selection screen 421 (S310: No), and the operator OP selects “NOT INCLUDED HERE” on the selection screen 421 (S312), the processing returns to step S32. In accordance with the voice teach input processing described in FIGS. 10 and 11, the robot teaching device 30 determines, in step S38, based on whether a word similar to a word included in the recognition target word is included in the recognized word, which recognition target word is originally intended. Thus, the operator OP, even when not remembering a recognition target word correctly, can give a desired instruction.

The program editing section 312 may include an operation program creation section 391 that newly creates a file for an operation program by using one or more words identified by the voice recognition section 311 as a file name. For example, when a predetermined key operation that newly creates an operation program in the robot teaching device 30 is performed and the voice activation switch 301a is operated, the operation program creation section 391 newly creates an operation program by using a word inputted by voice as a file name.

In addition, the robot teaching device 30 may further include an operation program storage section 318 for storing a plurality of operation programs, and the program editing section 312 may include an operation program selection section 392 for selecting one operation program of which an editing screen is created from the plurality of operation programs stored in the operation program storage section 318, based on one or more words identified by the voice recognition section 311. For example, when a key operation that displays a list of the operation programs stored in the operation program storage section 318 is performed in the robot teaching device 30, and the voice activation switch 301a is operated, the operation program selection section 392 selects an operation program corresponding to a word inputted by voice as an editing target.

While the invention has been described with reference to specific embodiments, it will be understood, by those skilled in the art, that various changes or modifications may be made thereto without departing from the scope of the following claims.

The program for executing the voice input processing (FIG. 3), the language switching processing (FIG. 5), and the voice input teaching processing (FIGS. 6, 8, and 10) illustrated in the embodiments described above can be recorded on various recording media (e.g., a semiconductor memory such as a ROM, an EEPROM or a flash memory, a magnetic recording medium, and an optical disk such as a CD-ROM or a DVD-ROM) readable by a computer.

1. A robot teaching device configured to perform teaching of a robot, the robot teaching device comprising:
a display device;
a microphone configured to collect voice and output a voice signal;
a voice recognition section configured to identify one or more words represented by the voice from the voice signal and output character data constituted by the one or more words;
a program editing section configured to create an editing screen of an operation program for the robot and display the editing screen on the display device; and
a comment input section configured to, in a state in which the editing screen of the operation program is displayed on the display device, add a word represented by the character data outputted from the voice recognition section, as a comment text, to a command in the operation program.

2. The robot teaching device according to claim 1, further comprising:
a correspondence storage section configured to store each of a plurality of types of commands used in teaching of the robot in association with a recognition target word;
a correspondence addition section configured to set the added comment text as a new recognition target word, and add, to the correspondence storage section, the new recognition target word while associating the new recognition target word with the command to which the comment text in the operation program is added;
a recognition target word determination section configured to determine whether the recognition target word stored in the correspondence storage section is included in the word represented by the character data; and
a command execution signal output section configured to output a signal for executing the command stored in the correspondence storage section in association with the recognition target word determined to be included in the word represented by the character data.

3. The robot teaching device according to claim 2, wherein
the voice recognition section includes a language selection section configured to accept operation input for selecting a language to be a target of recognition by the voice recognition section, and
the voice recognition section identifies the one or more words based on a language selected via the language selection section.

4. The robot teaching device according to claim 3, wherein
the recognition target word determination section is configured to, based on the language selected via the language selection section, determine whether the recognition target word is included in the word represented by the character data.

5. The robot teaching device according to claim 3, wherein
the voice recognition section includes dictionary data for a plurality of types of languages, estimates a language of the voice by using the dictionary data for the plurality of types of languages, and when the estimated language is different from the language being selected via the language selection section, displays an image representing a message prompting to switch the language being selected to the estimated language on the display device.

6. The robot teaching device according to claim 2, wherein
the command execution signal output section includes an execution permission requesting section configured to cause, before outputting the signal for executing the command, the display device to display an image representing a message requesting execution permission.

7. The robot teaching device according to claim 6, wherein
the execution permission requesting section determines whether execution of the command is permitted based on an input operation via an operation key.

8. The robot teaching device according to claim 6, wherein
the execution permission requesting section determines, based on the one or more words inputted as the voice signal via the microphone and identified by the voice recognition section, whether execution of the command is permitted.

9. The robot teaching device according to claim 2, wherein
the recognition target word determination section is configured to, when the word represented by the character data does not include the recognition target word stored in the correspondence storage section, extract the one or more recognition target words having predetermined association with the word represented by the character data from the correspondence storage section, and display a selection screen on the display device for accepting operation input to select one from the one or more commands associated with the extracted one or more recognition target words in the correspondence storage section.

10. The robot teaching device according to claim 1, wherein
the program editing section includes an operation program creation section that newly creates a file for an operation program by using the one or more words identified by the voice recognition section as a file name.

11. The robot teaching device according to claim 1, further comprising:
an operation program storage section configured to store a plurality of operation programs, wherein
the program editing section includes an operation program selection section configured to select, based on the one or more words identified by the voice recognition section, one operation program to be a target for creation of the editing screen, from the plurality of operation programs stored in the operation program storage section.
